(19) United States
(12) Patent Application Publication
(10) Pub. No.: US 2026/0277166 A1
(43) Pub. Date: Sep. 17, 2026

(54) ELECTRONIC TIMEPIECE

(71) Applicant: SEIKO WATCH KABUSHIKI KAISHA (trading as SEIKO WATCH CORPORATION), Tokyo (JP)

(72) Inventors: Masayuki NAKAMURA, Tokyo (JP); Kenji OGASAWARA, Tokyo (JP)

(21) Appl. No.: 19/459,632

(22) Filed: Jan. 26, 2026

(30) Foreign Application Priority Data
Mar. 14, 2025 (JP) 2025-041894

(51) Int. Cl. G04G 9/08

(52) U.S. Cl. CPC G04G 9/085; G04G 9/087

(57) ABSTRACT

An electronic timepiece capable of displaying information necessary for a user as large as possible is provided. The electronic timepiece includes a single display mode configured to selectively display any one element of a plurality of elements in a display area, and a multiple display mode configured to simultaneously display the plurality of the elements in the display area. In the single display mode, the element is displayed in a size larger than a display size of the corresponding element in the multiple display mode.

### RELATED APPLICATIONS

This application claims priority to Japanese Patent application No. JP2025-041894, filed on March 14, 2025, the entire content of which is incorporated herein by reference.

### BACKGROUND OF THE INVENTION

### 1. Field of the Invention

The present invention relates to an electronic timepiece.

### 2. Description of the Related Art

In the related art, a technique is known in which a first display unit that displays large information and a second display unit that displays small information are provided, and information displayed by the first display unit and the second display unit is switched according to a switching signal (PTL 1).

### 3. Citations

### Patent Literature

PTL 1: JPS61-17691A

### SUMMARY OF THE INVENTION

However, the second display unit also displays information in addition to the first display unit, and necessary information cannot be displayed alone in a large size.

The present disclosure has been made in view of the above, and an object of the present disclosure is to provide an electronic timepiece capable of displaying information necessary for a user as large as possible.

An electronic timepiece according to a first aspect includes a single display mode configured to selectively display any one element of a plurality of elements in a display area, and a multiple display mode configured to simultaneously display the plurality of the elements in the display area. In the single display mode, the element is displayed in a size larger than a display size of the corresponding element in the multiple display mode.

According to the electronic timepiece of the first aspect, information necessary for the user can be displayed as large as possible.

In the electronic timepiece according to a second aspect, in the single display mode, the element is displayed in a size in which at least one of a length in a vertical direction and a length in a horizontal direction is 1.5 times or more as large as that in the multiple display mode.

According to the electronic timepiece of the second aspect, it is possible for the user to display the element clearly larger in the single display mode than in the multiple display mode.

In the electronic timepiece according to a third aspect, in the single display mode, the element is displayed in a different font depending on the element to be displayed.

According to the electronic timepiece of the third aspect, types of elements to be displayed in the single display mode can be easily understood.

In the electronic timepiece according to a fourth aspect, in the single display mode, the element is displayed in a different text color depending on the element to be displayed.

According to the electronic timepiece of the fourth aspect, the types of elements displayed in the single display mode can be easily understood.

In the electronic timepiece according to a fifth aspect, in the single display mode, the element is displayed in a different background color depending on the element to be displayed.

According to the electronic timepiece of the fifth aspect, the types of elements displayed in the single display mode can be easily understood.

In the electronic timepiece according to a sixth aspect, a plurality of operation portions are provided, and the operation portions configured to switch between the multiple display mode and the single display mode are assigned to each of the elements.

According to the electronic timepiece of the sixth aspect, it is possible to switch between the single display mode and the multiple display mode by operating the operation portions.

In the electronic timepiece according to a seventh aspect, a switching operation of the corresponding element is assigned to one of the operation portions which is disposed at a position close to the element to be displayed.

According to the electronic timepiece of the seventh aspect, it is possible to intuitively operate switching between the single display mode and the multiple display mode.

According to the present disclosure, information necessary for the user can be displayed as large as possible.

### BRIEF DESCRIPTION OF THE DRAWINGS

FIG. 1 is a schematic external view of an electronic timepiece according to an embodiment of the invention.

FIG. 2 is a schematic block diagram of the electronic timepiece according to the embodiment of the invention.

FIG. 3 shows an example of a multiple display mode according to the embodiment of the invention.

FIGS. 4A, 4B, 4C and 4D show examples of a single display mode according to the embodiment of the invention.

FIG. 5 shows an example of switching between the multiple display mode and the single display mode according to the embodiment of the invention.

FIG. 6 is a flowchart showing an example of a flow of a switching process between the multiple display mode and the single display mode performed by a control circuit according to the embodiment of the invention.

FIG. 7 shows another example of the switching between the multiple display mode and the single display mode according to the embodiment of the invention.

FIG. 8 shows another example of the switching between the multiple display mode and the single display mode according to the embodiment of the invention.

FIG. 9 shows another example of the switching between the multiple display mode and the single display mode according to the embodiment of the invention.

FIG. 10 shows an example of a case of changing an angle of an element displayed in a display area according to the embodiment of the invention.

FIG. 11 shows an example in which the electronic timepiece according to the embodiment of the invention is set for a left hand or a right hand.

FIG. 12 shows an example of switching between the multiple display mode and the single display mode when a stopwatch function according to the embodiment of the invention is used.

FIG. 13 shows an example of switching between the multiple display mode and the single display mode when a counter function according to the embodiment of the invention is used.

### DETAILED DESCRIPTION OF THE PREFERRED EMBODIMENTS

Hereinafter, an example of an embodiment of the invention will be described with reference to the drawings. In the drawings, the same or equivalent components and portions are denoted by the same reference numerals. In addition, dimensional ratios in the drawings are exaggerated for convenience of description and may be different from actual ratios.

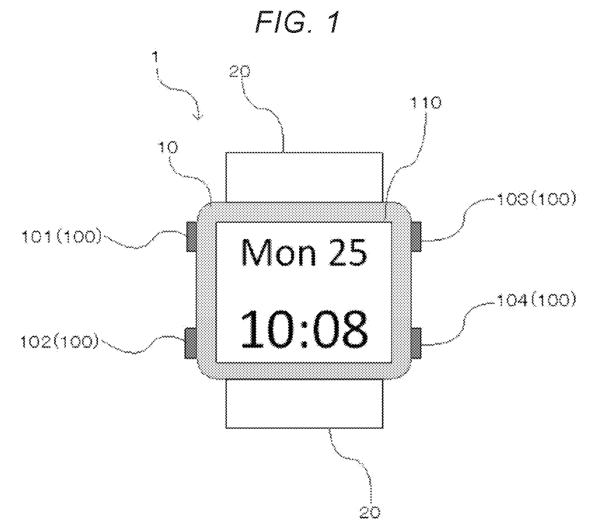

An example of an appearance of an electronic timepiece 1 according to the present embodiment will be described with reference to FIG. 1. As shown in FIG. 1, the electronic timepiece 1 includes a body 10 and a strap 20. The electronic timepiece 1 according to the present embodiment is attached to be wearable by winding the strap 20 around a user's arm.

The body 10 is formed in a substantially quadrangular shape having four curved corners. The body 10 includes a plurality of operation portions 100 and a display unit 110. The operation portions 100 and the display unit 110 will be described later. The electronic timepiece 1 executes processes corresponding to the operation portions 100 by receiving operations of the operation portions 100 by the user.

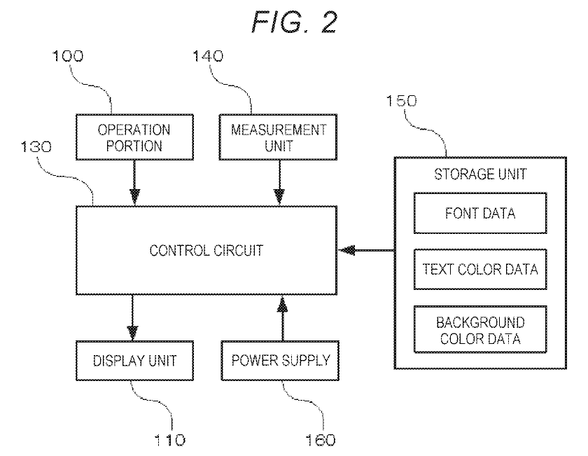

Next, a hardware configuration of the electronic timepiece 1 according to the present embodiment will be described. FIG. 2 is a functional block diagram of the electronic timepiece 1 according to the present embodiment.

As shown in FIG. 2, the electronic timepiece 1 according to the present embodiment includes a control circuit 130, the operation portions 100, a measurement unit 140, a storage unit 150, the display unit 110, and a power supply 160. Each component is communicably connected to the control circuit 130 via a bus. The control circuit 130, the measurement unit 140, the storage unit 150, and the power supply 160 are stored inside the body 10.

The control circuit 130 controls the above components and performs various arithmetic processes.

The operation portions 100 are switches that can be operated, for example, pressed, by a user. In the present embodiment, two operation portions 100 are provided on each of a left side and a right side. The operation portions 100 provided on the left side include a first operation portion 101 located on an upper side of the left side and a second operation portion 102 located on a lower side.

The measurement unit 140 measures time using an oscillation circuit or the like, and measures a count value obtained by a user operating the operation portion.

The storage unit 150 stores data (font data) related to a font of a text, data (text color data) related to a text color, and data (background color data) related to a background color, which are to be used when displaying various elements in a display area 111 of the display unit 110. Here, each piece of data includes data for multiple display mode, data for minute information, data for hour information, data for date information, data for day of week information, and the like. For example, a font A, a text color of black, and a background color of white are stored in the data for multiple display mode. In addition, the font A, the text color of black, and the background color of white are stored in the data for day of week information in the single display mode. In addition, a font B (italic), the text color of black, and the background color of white are stored in the data for date information in the single display mode. In addition, a font C, the text color of black, and the background color of white are stored in the data for hour information in the single display mode. In addition, the font C, a text color of white, and a background color of black are stored in the data for minute information in the single display mode. A combination of the font, the text color, and the background color is not limited to the combinations described above, and may be another combination. In addition, the font data may include data that adds italic, bold, and underline even to the same typeface.

The display unit 110 is, for example, a liquid crystal display, and displays various types of information in the display area 111 under the control of the control circuit 130. The elements displayed in the display area 111 of the display unit 110 include time information (hour information and minute information) related to time, day of week information related to a day of week, date information related to a date, and the like.

The power supply 160 is a device that supplies power to the control circuit 130 such as a battery. In the present embodiment, the power is supplied to each component of the electronic timepiece 1 via the control circuit 130.

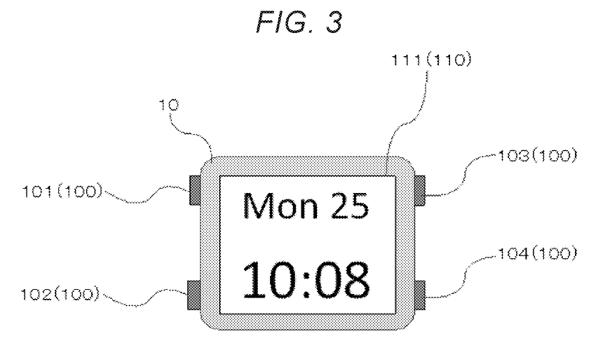

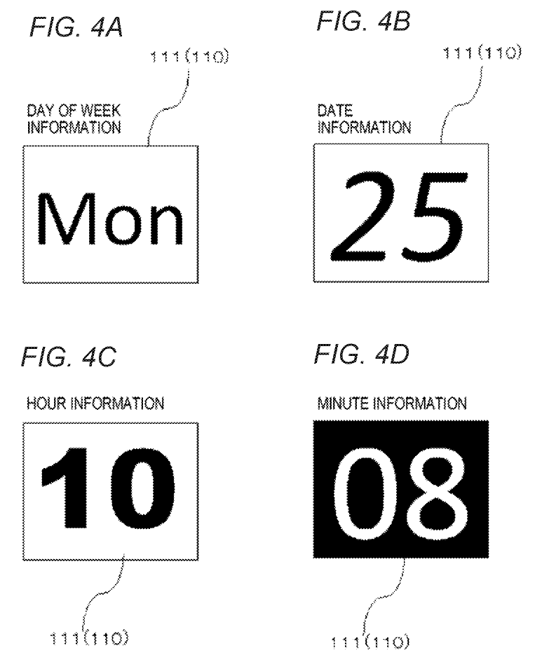

Next, display of the single display mode and the multiple display mode will be described with reference to FIGS. 3 and 4A-4D.

In the present embodiment, as a mode of displaying the elements in the display area 111 of the display unit 110, there is the single display mode in which only one element among a plurality of elements can be selectively displayed in the display area and the multiple display mode in which a plurality of elements can be simultaneously displayed in the display area. The control circuit switches between the single display mode and the multiple display mode and displays the elements in the display area of the display unit.

In the multiple display mode, for example, as shown in FIG. 3, the day of week information ("Mon" indicating Monday) is displayed on upper left of the display area 111, the date information ("25" indicating 25th) is displayed on upper right, hour information ("10" indicating 10:00) is displayed on lower left, and minute information ("08" indicating 8 minutes) is displayed on lower right. The multiple display mode is an initial state in which the user does not operate the operation portion 100.

In the single display mode, each element is displayed in a display form different from that in the multiple display mode. In the present embodiment, as shown in FIG. 4A, among the day of week information, the date information, the hour information, and the minute information displayed in the multiple display mode (see FIG. 3), the day of week information is displayed in a size larger than a display size of the corresponding day of week information in the multiple display mode. In addition, as shown in FIG. 4B, among the day of week information, the date information, the hour information, and the minute information displayed in the multiple display mode (see FIG. 3), the date information is displayed in a size larger than a display size of the corresponding date information in the multiple display mode. In addition, as shown in FIG. 4C, among the day of week information, the date information, the hour information, and the minute information displayed in the multiple display mode (see FIG. 3), the hour information is displayed in a size larger than a display size of the corresponding hour information in the multiple display mode. In addition, as shown in FIG. 4D, among the day of week information, the date information, the hour information, and the minute information displayed in the multiple display mode (see FIG. 3), the minute information is displayed in a size larger than a display size of the corresponding minute information in the multiple display mode.

Here, the larger size includes performing display in a larger proportion in the display area 111 of the display unit 110, and for example, at least one of a length in a vertical direction and a length in a horizontal direction of the element displayed in the single display mode is displayed to be 1.5 times or more, preferably twice or more larger than those in the multiple display mode. That is, in the single display mode, at least one of the sizes in the vertical direction and the horizontal direction of the text or the like used when displaying the element is displayed 1.5 times or more, preferably 2 times or more larger than that in the multiple display mode.

Note that the single display mode is not limited to the case of displaying only one element to be displayed in the display area 111, and does not preclude simultaneous display of elements not included in a target to be displayed in a large size in the single display mode. For example, when information indicating morning and afternoon is an element that is not included in the target to be displayed in the large size in the single display mode, the information may be displayed in a size smaller than the size in which the hour information is displayed in the single display mode.

In addition, in the present embodiment, in the single display mode, the element is preferably displayed in at least one of a different font, a different text color, and a different background color according to the element to be displayed. Specifically, the day of week information is displayed in the font A, the text color of black, and the background color of white, the date information is displayed in the font B (italic), the text color of black, and the background color of white, the hour information is displayed in the font C, the text color of black, and the background color of white, and the minute information is displayed in the font C, the text color of white, and the background color of black.

The display forms such as the font, the text color, and the background color in the single display mode for each element are preferably described in a manual or the like distributed to users. In addition, the display forms such as the font, the text color, and the background color for each element in the multiple display mode are preferably the same, but even in the multiple display mode, the display forms may be displayed in the same font, text color, and background color as in the single display mode.

The operation portions 100 for switching between the multiple display mode and the single display mode are assigned to each element. That is, the multiple display mode and the single display mode are switched by the user operating the corresponding operation portions 100.

In the present embodiment, a switching operation of the corresponding element is preferably assigned to the operation portion 100 disposed at a position close to the element to be displayed. Specifically, in the case of the multiple display mode in which a plurality of elements are displayed in an arrangement shown in FIG. 3, the first operation portion 101 disposed at a position closest to the day of week information, the third operation portion 103 disposed at a position closest to the date information, the second operation portion 102 disposed at a position closest to the hour information, and the fourth operation portion 104 disposed at a position closest to the minute information are assigned to the day of week information, the date information, the hour information, and the minute information, respectively. In addition, in order not to confuse the operation portion 100 to be selected by the user, the arrangement of each element when the plurality of elements are displayed is preferably, for example, an arrangement in which the day of week information is not at the same distance from both the first operation portion 101 and the second operation portion 102 so as not to be at equal distance from the plurality of operation portions 100.

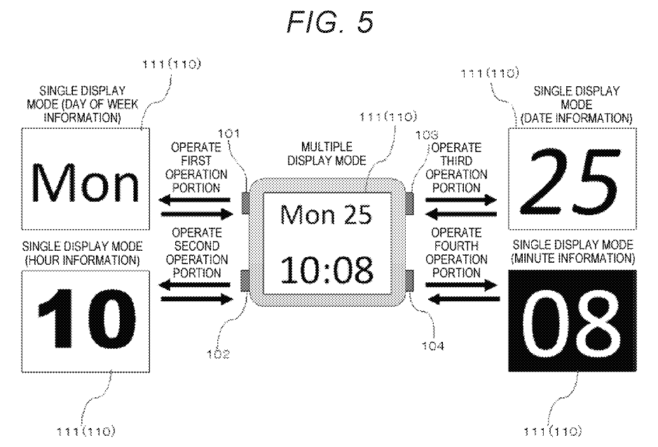

As shown in FIG. 5, when the first operation portion 101 is operated, the multiple display mode is switched to the single display mode in which the day of week information is displayed. When the same first operation portion 101 is operated from the corresponding single display mode, the display mode returns to the multiple display mode.

Similarly, when the second operation portion 102 is operated, the multiple display mode is switched to the single display mode in which the hour information is displayed. When the same second operation portion 102 is operated from the corresponding single display mode, the display mode returns to the multiple display mode.

Similarly, when the third operation portion 103 is operated, the multiple display mode is switched to the single display mode in which the date information is displayed. When the same third operation portion 103 is operated from the corresponding single display mode, the display mode returns to the multiple display mode.

Similarly, when the fourth operation portion 104 is operated, the multiple display mode is switched to the single display mode in which the minute information is displayed. When the same fourth operation portion 104 is operated from the corresponding single display mode, the display mode returns to the multiple display mode.

When the operation portion 100 other than the operation portion 100 assigned to the element displayed in the single display mode is operated, the single display mode is switched to a single display mode in which the element assigned to the corresponding operation portion 100 is displayed. For example, when the second operation portion 102 other than the first operation portion 101 assigned to the day of week information is operated, the single display mode in which the day of week information is displayed is switched to a single display mode in which the hour information assigned to the second operation portion 102 is displayed.

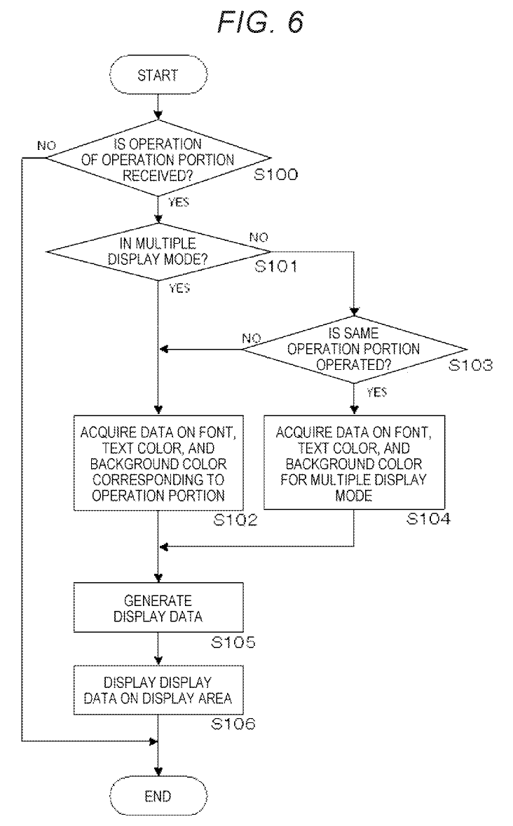

Next, operations of the control circuit 130 according to the present embodiment will be described with reference to FIG. 6.

FIG. 6 is a flowchart showing an example of a flow of a switching process between the multiple display mode and the single display mode performed by the control circuit 130.

In step S100, the control circuit 130 determines whether an operation of the operation portion 100 is received. When it is determined that the operation of the operation portion 100 is received, the process proceeds to the next step S101. On the other hand, when it is determined that the operation of the operation portion 100 is not received, the process ends.

In step S101, the control circuit 130 determines whether a current display mode is the multiple display mode. When it is determined that the current display mode is the multiple display mode, the process proceeds to the next step S102.

In step S102, the control circuit 130 acquires the font data, the text color data, and the background color data corresponding to the operation portion 100 received in step S100 from the storage unit 150. That is, in the case of the multiple display mode as shown in FIG. 1, when the operation of the first operation portion 101 is received, the font data, the text color data, and the background color data for the day of week information are acquired from the storage unit 150. When the operation of the third operation portion 103 is received, the font data, the text color data, and the background color data for the date information are acquired from the storage unit 150. When the operation of the second operation portion 102 is received, the font data, the text color data, and the background color data for the hour information are acquired from the storage unit 150. When the operation of the fourth operation portion 104 is received, the font data, the text color data, and the background color data for the minute information are acquired from the storage unit 150. Then, the process proceeds to the next step S105.

On the other hand, when it is determined in step S101 described above that the display mode is not the multiple display mode, that is, when the display mode is the single display mode, the process proceeds to step S103.

In step S103, the control circuit 130 determines whether the same operation portion 100 as the operation portion 100 corresponding to the element in the single display mode is operated. That is, in the case of the single display mode of the day of week information, it is determined whether the first operation portion 101 is operated. In the case of the single display mode of the date information, it is determined whether the third operation portion 103 is operated. In the case of the single display mode of the hour information, it is determined whether the second operation portion 102 is operated. In the case of the single display mode of the minute information, it is determined whether the fourth operation portion 104 is operated. When it is determined that the same operation portion 100 is operated, the process proceeds to the next step S104. On the other hand, when it is determined that the same operation portion 100 is not operated, the process proceeds to step S102 described above.

In step S104, the control circuit 130 acquires the font data for the multiple display mode from the storage unit 150. Then, the process proceeds to step S105.

In step S105, the control circuit 130 generates display data to be displayed in the display area 111 using the font data, the text color data, and the background color data acquired in step S102 or step S104 described above. Then, the process proceeds to the next step S106.

In step S106, the control circuit 130 displays the display data generated in step S105 described above in the display area 111. Then, the process ends.

The invention is not limited to the embodiment described above, and various modifications other than those described above can be made without departing from the spirit of the invention.

The shape of the body 10 is not limited to the substantially quadrangular shape, and may be another shape. For example, the body 10 may have a substantially circular shape or a substantially polygonal shape other than the substantially quadrangular shape. When the electronic timepiece 1 is worn on an arm of a user, the operation portions 100 may be provided on an outer edge located on a finger side of the arm and an outer edge located on an elbow side of the arm, respectively.

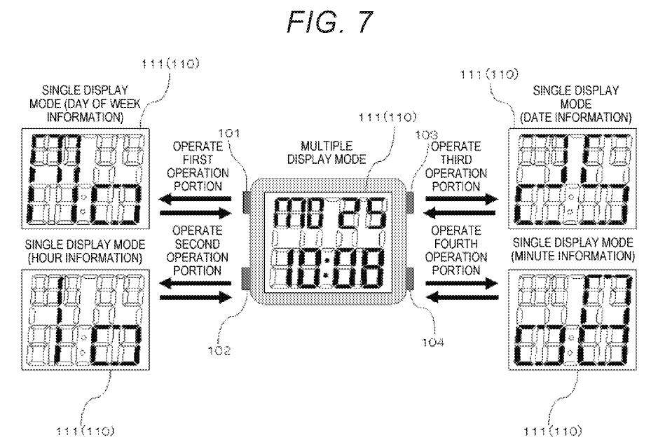

The display unit 110 is not limited to the liquid crystal display and may be a segment display. In this case, as shown in FIG. 7, the user operates the operation portion 100 in the multiple display mode to switch to the single display mode, and the element corresponding to the operation portion 100 is displayed in a large size.

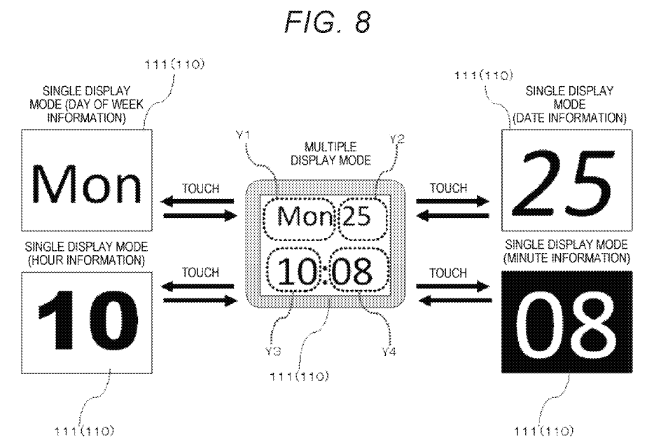

The operation portion 100 is not limited to the switch described above, and may be a touch panel in addition to or instead of the switch described above. In this case, as shown in FIG. 8, the single display mode is switched by the user touching a predetermined range Y of each element in the multiple display mode, and the element corresponding to the predetermined range Y is displayed in a large size. Specifically, the day of week information may be displayed in the single display mode when the user touches a range Y1 corresponding to the day of week information, the date information may be displayed in the single display mode when the user touches a range Y2 corresponding to the date information, the hour information may be displayed in the single display mode when the user touches a range Y3 corresponding to the hour information, and the minute information may be displayed in the single display mode when the user touches a range Y4 corresponding to the minute information.

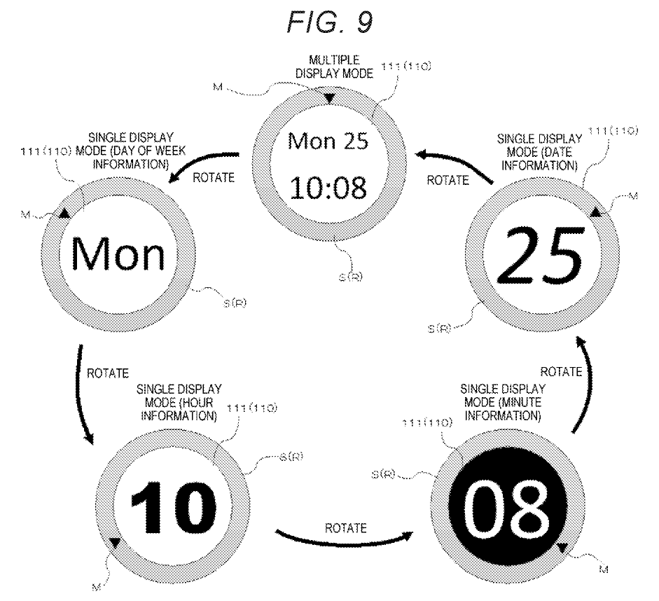

The operation portion 100 may be a rotary switch R. In this case, as shown in FIG. 9, the rotary switch R is incorporated in a bezel S portion of the electronic timepiece, and the rotary switch R is rotated together with the bezel S to align a mark at a position of each element, so as to switch to the single display mode, and the element aligning the corresponding mark is displayed in a large size.

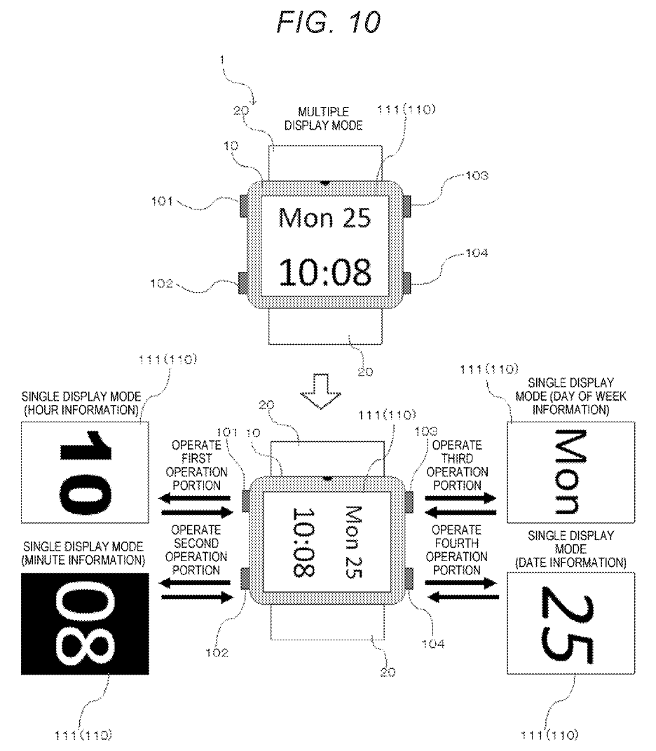

An angle of the elements displayed in the display area 111 may be changed. In the embodiment described above, in a normal display state in which the elements are not rotated in an initial state, when the electronic timepiece 1 is worn on an arm, the elements are displayed such that a direction orthogonal to the arm is an upper-lower direction of the display, and the user may set the angle to any angle. FIG. 10 is an example of a case where the user performs a setting by rotating the elements to the right by 90 degrees from the normal display state. Accordingly, the electronic timepiece 1 can be used not only as a wristwatch worn on the user's arm but also as a table clock. In this case, the operation portion 100 assigned to each element in the normal display state is assigned to another element. That is, since the switching operation of the element is assigned to the operation portion 100 disposed at a position close to the element, for example, in the normal display state, the first operation portion 101 is assigned to the day of week information, but in the state in which the elements are rotated to the right by 90 degrees shown in FIG. 10, the first operation portion 101 is disposed at a position close to the hour information, and thus is assigned to the hour information. Similarly, in the normal display state, the second operation portion 102 is assigned to the hour information, but in the state in which the elements are rotated to the right by 90 degrees shown in FIG. 10, the second operation portion 102 is disposed at a position close to the minute information, and thus is assigned to the minute information. Similarly, in the normal display state, the third operation portion 103 is assigned to the date information, but in the state in which the elements are rotated to the right by 90 degrees shown in FIG. 10, the third operation portion 103 is disposed at a position close to the day of week information, and thus is assigned to the day of week information. Similarly, in the normal display state, the fourth operation portion 104 is assigned to the minute information, but in the state in which the elements are rotated to the right by 90 degrees shown in FIG. 10, the fourth operation portion 104 is disposed at a position close to the date information, and thus is assigned to the date information.

Note that the angle of the elements is changed by performing a predetermined operation on any of the operation portions 100 (for example, a long press of the operation portion 100 for a predetermined time or a simultaneous press of the plurality of operation portions 100).

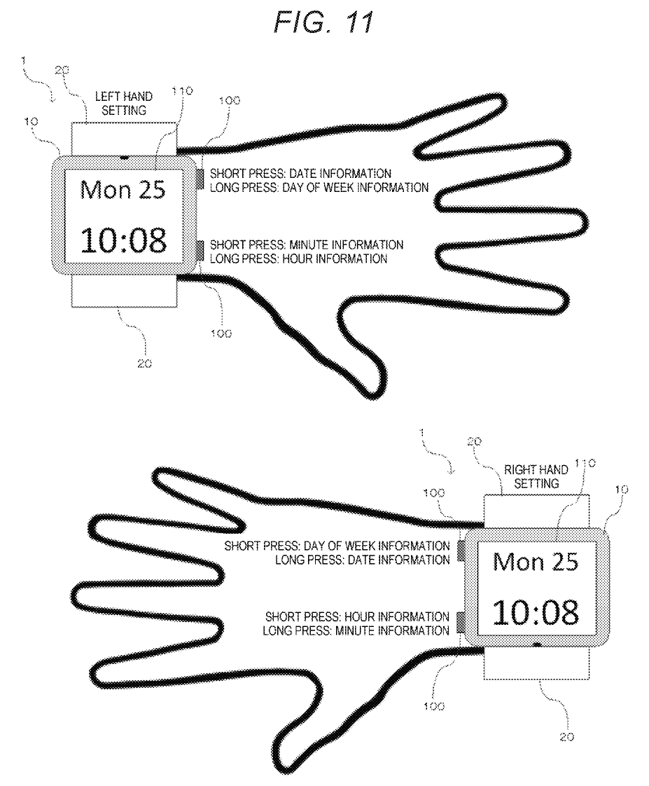

Further, the operation portion 100 is not limited to the case where two operation portions 100 are provided on each of the left side and the right side, and may include one operation portion 100 or three or more operation portions 100. The operation portion 100 may be provided on only one of the left side and the right side. When the operation portion 100 is provided on only one of the left side and the right side, as shown in FIG. 11, the operation portion 100 for a left hand or a right hand may be set by a setting of the user. For the left hand and the right hand, the display of the elements is rotated such that the operation portion is located on a finger side of the arm regardless of whether the electronic timepiece is worn on the left hand or the right hand. When the operation portion 100 is provided on only one of the left side and the right side, in the assignment of the switching of the display of each element of the operation portion 100, the switching of the display of a plurality of elements can be assigned by one operation portion by a short press for less than a predetermined time or a long press for a predetermined time or more. For example, in the case shown in FIG. 11, switching to the single display mode of information (day of week information and date information) displayed on an upper side of the display area 111 is assigned to the upper operation portion 100. Further, switching to the single display mode of information (hour information and minute information) displayed on a lower side of the display area 111 is assigned to the lower operation portion 100. The short press is assigned to an element close to the operation portion, and the long press is assigned to an element far from the operation portion. Specifically, when the left hand is set, the short press of the upper operation portion 100 is the date information, and the long press is the day of week information, and when the right hand is set, the short press of the upper operation portion 100 is the day of week information, and the long press is the date information. By enabling such a setting, in particular, in the case of a user having an obstacle in one hand, the operation portion 100 can be easily operated regardless of whether the electronic timepiece is worn on the right hand or the left hand, which is the arm that is easier to use.

Note that the left hand or the right hand is changed by performing a predetermined operation on any of the operation portions 100 (for example, long pressing of the operation portion 100 for a predetermined time or simultaneous pressing of the plurality of operation portions 100).

The elements displayed in the display area 111 of the display unit 110 are not limited to the time information (hour information and minute information), the day of week information, and the date information described above. The element may be a measurement time of a stopwatch function, a count value of a count function obtained by operating the operation portion 100, or the like.

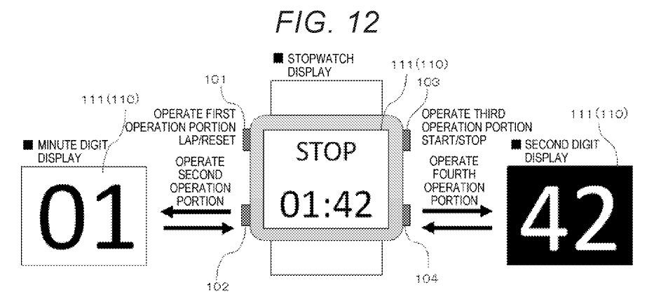

In the case of the measurement time of a stopwatch, as shown in FIG. 12, for example, a LAP/RESET function of the stopwatch is assigned to the first operation portion 101, a START/STOP function of the stopwatch is assigned to the third operation portion 103, a function of switching to minute digit display of the measurement time is assigned to the second operation portion 102, and a function of switching to second digit display of the measurement time is assigned to the fourth operation portion 104.

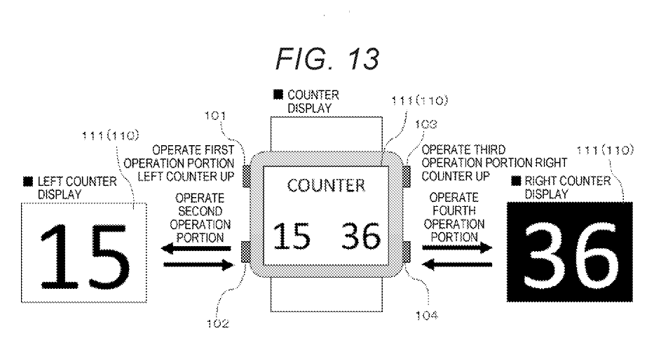

In the case of the count value obtained by operating the operation portion 100, as shown in FIG. 13, for example, a function of increasing the count value displayed on the left side is assigned to the first operation portion 101, a function of increasing the count value displayed on the right side is assigned to the third operation portion 103, a function of switching to display of the count value displayed on the left side is assigned to the second operation portion 102, and a function of switching to display of the count value displayed on the right side is assigned to the fourth operation portion 104. This counting function is a function to be used to count two values such as the number of basketball or soccer goals.

Note that the state in which the time is displayed (see FIG. 1) is changed to the state in which the stopwatch function or the count function is used by performing a predetermined operation on any of the operation portions 100 (for example, a long press of the operation portion 100 for a predetermined time or a simultaneous press of the plurality of operation portions 100).

Further, the invention is not limited to the case where the switching operation of the element is assigned to the operation portion 100 disposed at a position close to the element to be displayed, and each element may be switched and displayed in the single display mode every time the predetermined operation portion 100 is operated. Specifically, the day of week information may be displayed in the single display mode when the first operation portion 101 is operated once, the date information may be displayed in the single display mode when the first operation portion 101 is operated twice, the hour information may be displayed in the single display mode when the first operation portion 101 is operated three times, the minute information may be displayed in the single display mode when the first operation portion 101 is operated four times, and the display mode may return to the multiple display mode when the first operation portion 101 is operated five times.

According to the present embodiment, information necessary for the user can be displayed as large as possible. That is, the size of the display area 111 of the electronic timepiece 1 worn on the arm is generally limited. Therefore, when a plurality of various pieces of information are displayed at the same time, the size of one piece of information becomes small, and necessary information becomes difficult to see. In particular, it is often difficult for a user with weak vision to read information displayed in a small size. Therefore, in the present embodiment, the information to be displayed can be selected by the user, so that necessary information can be reliably read.

Note that the following appendices are further disclosed with respect to the above-described embodiment of the technology disclosed in the present application.

### Appendix 1

An electronic timepiece includes:

a single display mode configured to selectively display any one element of a plurality of elements in a display area; and

a multiple display mode configured to simultaneously display a plurality of the elements in the display area, in which

in the single display mode, the element is displayed in a size larger than a display size of the element in the multiple display mode.

### Appendix 2

The electronic timepiece according to Appendix 1, in which

in the single display mode, the element is displayed in a size in which at least one of a length in a vertical direction and a length in a horizontal direction is 1.5 times or more as large as that in the multiple display mode.

### Appendix 3

The electronic timepiece according to Appendix 1 or 2, in which

in the single display mode, the element is displayed in a different font depending on the element to be displayed.

### Appendix 4

The electronic timepiece according to any one of Appendixes 1 to 3, in which

in the single display mode, the element is displayed in a different text color depending on the element to be displayed.

### Appendix 5

The electronic timepiece according to any one of Appendixes 1 to 4, in which

in the single display mode, the element is displayed in a different background color depending on the element to be displayed.

### Appendix 6

The electronic timepiece according to any one of Appendixes 1 to 5, further includes:

a plurality of operation portions, in which

the operation portions configured to switch between the multiple display mode and the single display mode are assigned to each of the elements.

### Appendix 7

The electronic timepiece according to Appendix 6, in which

a switching operation of the corresponding element is assigned to one of the operation portions which is disposed at a position close to the element to be displayed.

What is claimed is:

1. An electronic timepiece comprising:
a single display mode configured to selectively display any one element of a plurality of elements in a display area; and
a multiple display mode configured to simultaneously display the plurality of the elements in the display area, wherein
in the single display mode, the element is displayed in a size larger than a display size of the corresponding element in the multiple display mode.

2. The electronic timepiece according to claim 1, wherein
in the single display mode, the element is displayed in a size in which at least one of a length in a vertical direction and a length in a horizontal direction is 1.5 times or more as large as that in the multiple display mode.

3. The electronic timepiece according to claim 1, wherein
in the single display mode, the element is displayed in a different font depending on the element to be displayed.

4. The electronic timepiece according to claim 1, wherein
in the single display mode, the element is displayed in a different text color depending on the element to be displayed.

5. The electronic timepiece according to claim 1, wherein
in the single display mode, the element is displayed in a different background color depending on the element to be displayed.

6. The electronic timepiece according to claim 1, further comprising:
a plurality of operation portions, wherein
the operation portions configured to switch between the multiple display mode and the single display mode are assigned to each of the elements.

7. The electronic timepiece according to claim 6, wherein
a switching operation of the corresponding element is assigned to one of the operation portions which is disposed at a position close to the element to be displayed.
